(19) United States
(12) Patent Application Publication
(10) Pub. No.: US 2016/0050284 A1
(43) Pub. Date: Feb. 18, 2016

(54) ZONE ALLOCATION IN A ZONE-BASED CONTENT SHARING PLATFORM

(71) Applicant: Yik Yak, Inc., Atlanta, GA (US)

(72) Inventors: Tyler Droll, Atlanta, GA (US); Brooks Buffington, Atlanta, GA (US)

(21) Appl. No.: 14/531,588

(22) Filed: Nov. 3, 2014

Related U.S. Application Data
(63) Continuation-in-part of application No. 14/458,829, filed on Aug. 13, 2014.

(51) Int. Cl. H04L 29/08; H04L 12/24

(52) U.S. Cl. CPC H04L 67/18; H04L 41/04

(57) ABSTRACT

Zone allocation in a zone-based content sharing platform may be provided. The platform may be configured for receiving a selection of a zone; assigning the requested zone to a host; and enabling the host to administer the zone. Assigning the requested zone to the host may comprise enabling the host to administer the zone. Administering the zone may comprise, for example, enabling the host to moderate and/or promote the content shared within the zone. The host may further be enabled to control access to content shared within the zone. The assignment may last for a period of time. Upon the expiration of the period of time, the host may be unassigned from the zone and, thus, have their administrative control of the zone relinquished.

### RELATED APPLICATION

Applicant claims the benefit of U.S. patent application Ser. No. 14/458,829, filed Aug. 13, 2014, entitled “Zone-Based Anonymous Content Sharing,” assigned to the assignee of the present application, and is incorporated herein by reference. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to the field of zoned-based allocation and content sharing over a telecommunications network.

### BACKGROUND

Networking applications have become a pervasive means for connecting people. Some networking applications are designed to connect friends together (e.g. social networking applications), facilitate business connections (e.g., business networking applications), or connect individuals who are interested in the same subject matter (e.g., dating networking applications).

Often times, individuals or entities (the “admin”) desire to create proprietary networks. Such proprietary networks may be used by the admin to, for example, facilitate discussion, provide marketing materials, and maintain a relationship with the proprietary network's members. The conventional networking applications enable the admin to create a ‘page’ within the conventional network. The network members may be enabled to add the admin's page to their own network. In this way, the conventional network applications enable the admin to facilitate discussion, provide marketing materials, and maintain a relationships with those that have added the admin's page to their own network.

Unfortunately, such networks are generally organized by social relationship, business dealings, or common issue, without the regard to, for example, organizational domain or geographic proximity. Moreover, the disclosure of personal identities, social relationships, and business dealings serves to impede and, often times, prevent the free flow of ideas and information.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Zone allocation in a zone-based content sharing platform may be provided. The platform may be configured for receiving a selection of a zone; assigning the requested zone to a host; and enabling the host to administer the zone.

In some embodiments, receiving the request to host the zone comprises receiving at least one of the following: a set of coordinates corresponding to the requested zone, a location associated with the requested zone, a name of a venue associated with the requested zone, and an event associated with the requested zone.

Still consistent with embodiments of the present disclosure, assigning the requested zone to the host may comprise enabling the host to administer the zone. Administering the zone may comprise, for example, enabling the host to moderate and/or promote the content shared within the zone. The host may further be enabled to control access to content shared within the zone. The assignment may last for a period of time. Upon the expiration of the period of time, the host may be unassigned from the zone and, thus, have their administrative control of the zone relinquished.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with embodiments of the present disclosure;

FIG. 2 is a flow chart of a method for providing zone allocation in a zone-based content sharing platform;

FIG. 3 is an illustration showing zone allocation in a zone-based content sharing platform;

FIG. 4 is a block diagram of a system including a computing device for performing various methods disclosed herein.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. The present disclosure contains headers. It should be understood that these headers are used as references and are not to be construed as limiting upon the subjected matter disclosed under the header.

### I. PLATFORM OVERVIEW

Consistent with embodiments of the present disclosure, zone allocation in a zone-based content sharing platform may be provided. The platform may comprise methods, systems, devices, computer-readable media, and telecommunications networks for providing the zone based anonymous content sharing. Content may include, but not be limited to, for example, graphic, text, audio, video, and/or combinations thereof.

The platform of the present disclosure may enable users to view, post, share, or otherwise interact with content in a dynamic zone. In some embodiments, the viewing, posting, sharing, or otherwise interacting with content may be anonymous. The zone may be ‘dynamic’ in the sense that the network connections available to a platform user may be based on, for example, dynamic parameters. The dynamic parameters may include, but not be limited to, a geographic location of a user, a network location of the user, an access time, and/or other variables that may change from time-to-time.

As will be detailed below, using the dynamic parameters, the platform may be configured to connect users based on, for example, their location relative each other, a region, or a predefined zone. In turn, as the dynamic parameters change (due to, for example, a change of user location), the network connections available to the platform user may also change. In this way, the zone of network connections available to the user may be dynamic, constantly changing based on updated parameters (e.g., user-location, time of access, and the like).

Still consistent with embodiments of the present disclosure, the platform may enable users to anonymously view content that is being shared in a predefined zone. The zone may be ‘predefined’ in the sense that the network connections available to a platform user within the zone may be based on, but not be limited to, for example, a content subject matter, an organizational affiliation, a geographical location, or a proximity thereto.

In some embodiments, the platform may be operative to provide users with a set of selection parameters in order to determine which predefined zone to join. For example, the user may be enabled to select, but not be limited to, a subject matter category, an organization, a location on a map, or a location of another platform user. Based on the user-selection, the platform may then connect the user to other users within the predefined zone. The other platform users within the predefined zone may be associated with the zone based on, for example, their corresponding dynamic parameters (e.g., their geographic location). In this way, a predefined zone for one platform user may correspond to, or overlap with, a dynamic zone of another platform user.

Accordingly, the platform of the present disclosure may provide a user with network connections based on either dynamic parameters (i.e., a dynamic zone) or user-selected parameters (i.e., a predefined zone). In various embodiments, the zone (either dynamic or predefined) to which the user is associated with may be hosted by a person or entity. The host of a zone may be a user of the platform with special platform privileges (e.g., an administrator of the platform).

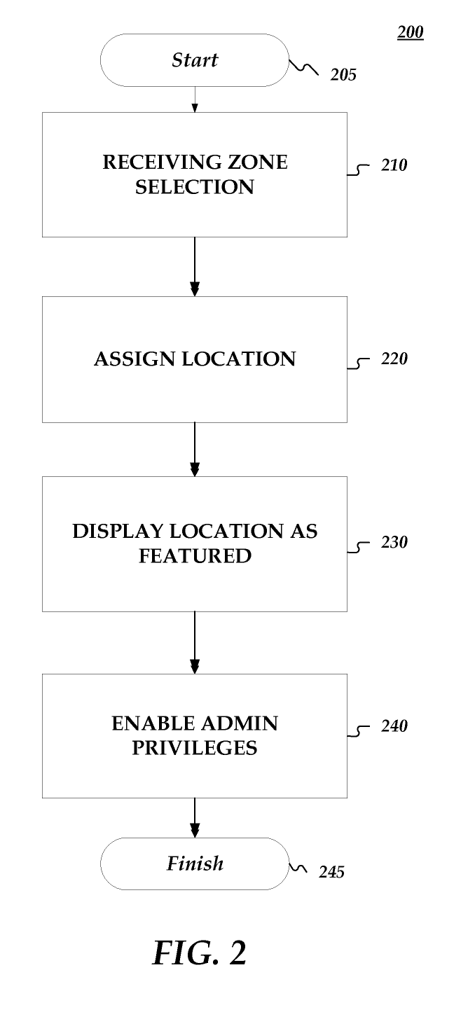

The host may be enabled to specify various parameters for the zone. The parameters may include, for example, but not be limited to, a territory, time, venue, event, and display name associated with the zone. Once a zone is associated with the host, the host of the zone may receive additional functions for interacting with platform users within the parameters of the host's zone. The functions may be not also be available to other users of the platform who are not hosting a zone. The functions may include, but not be limited to, for example, those functions disclosed with reference to FIG. 2 below.

Still consistent with embodiments of the present disclosure, the host may receive information associated with the platform users within the zone. The information may include, for example, but not be limited to, those functions disclosed with reference to FIG. 2 below. Such information may be presented to the host by the platform in the form of reports.

### II. PLATFORM CONFIGURATION

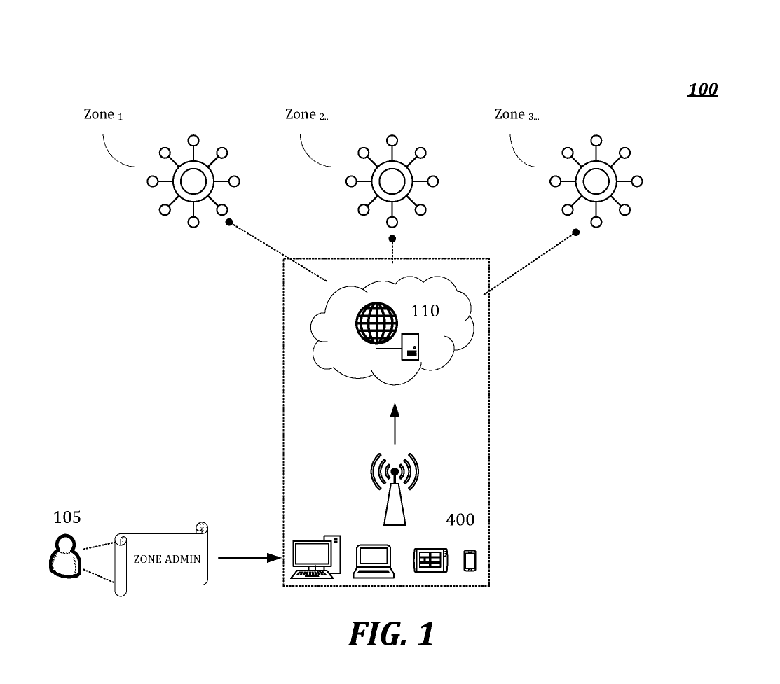

FIG. 1 illustrates one possible operating environment through which a platform consistent with embodiments of the present disclosure may be provided. By way of non-limiting example, platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 400. One possible embodiment of the software application may be provided by the Yik Yak™ suite of products and services provided by Yik Yak, Inc.

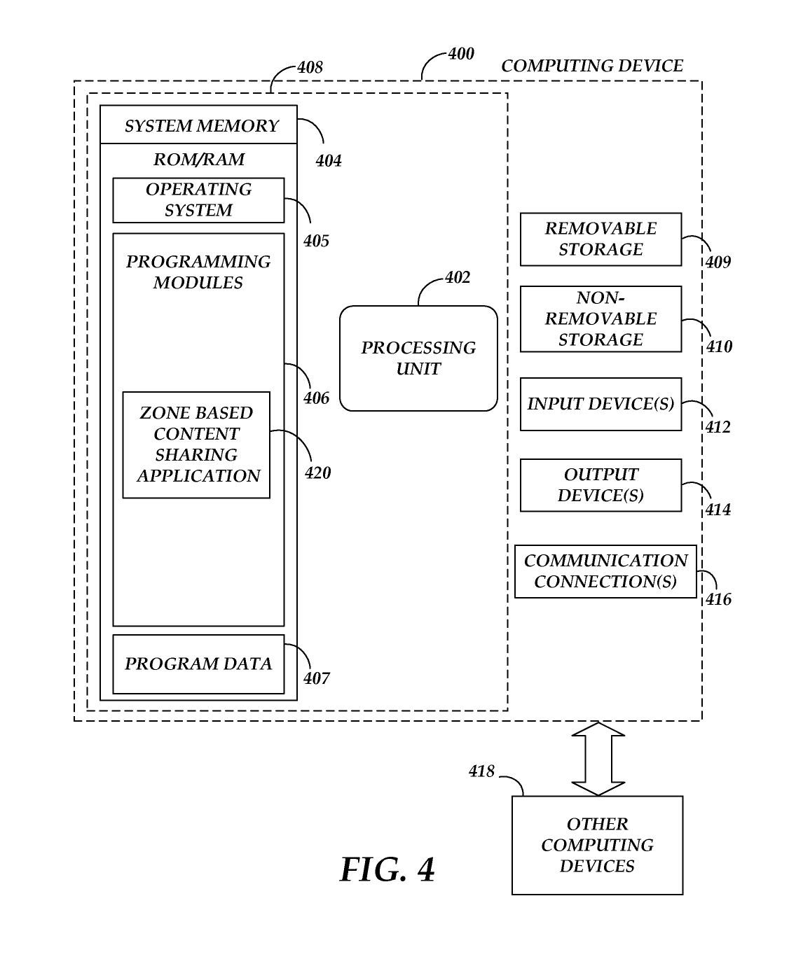

User 105 may be, for example, a host of the platform having administrative privileges. As will be detailed with reference to FIG. 4 below, user 105 may access a platform via a computing device. The computing device may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

Administrative privileges may be granted to the host via server 110. Server 110 may be configured to provide Zone-Based Content Sharing. Server 110 and its functionality is further described in “Zone Based Anonymous Content Sharing,” US patent application Ser. No. 14/458,829, the content of which is incorporated herein in its entirety. In addition, server 110 may be configured to provide Zone Allocation to administrators in accordance to method 200 described below.

The platform of the present disclosure may enable the sharing of content between users in a common zone. The content may comprise textual, graphical content, audio content, or any combinations thereof. The users may access the platform via, for example, a computing device 400. Computing device 400 may be a mobile computing device such as, for example, but not limited to, a user's smartphone or tablet device. The mobile computing device may comprise location detection components and software such as, for example, a global positioning system (GPS), triangulation means, internet protocol (IP) address tracking, and the like.

A zone based content sharing application of the platform may be installed on computing device 600. The application may enable the device user to access the platform of the present disclosure. In turn, the platform, through the application, may be granted access to the location data provided through the location detection modules associated with the user's device.

Having the user's location data, the platform may then be enabled to build a network zone for the user. The platform may connect the user with other platform users who fall into the user's zone. Once connected, the platform may be enabled to display all content shared to the platform within the zone.

Consistent with embodiments of the present disclosure, the zone may be established several ways. For example, in various embodiments, the zone may be associated with a dynamically calculated area around a user. The dynamic area may be calculated based on a predefined radius extending from the location of the user. The size of the radius may be determined by, for example, a platform administrator or, in some embodiments, the user of the platform.

In various other embodiments, the zone may be associated with a predefined area to which the user may proximately be located. The predefined area may include, but not be limited to, for example, a region (e.g., an area defined on a map), a campus (e.g., school, mall, park), physical infrastructure (e.g., a building or set of buildings), a network connection (e.g., Wi-Fi Local Area Network, Wide-Area network), and the like.

Such predefined areas may be determined and set by the platform administrators. For example, the administrators may divide a given city into quadrants, and based on which quadrant of the city a user is in, the platform may connect users within the quadrant. In further embodiments, predefined area may be determined by the selection of a center-point and may be designated by an area formed by a specified radius emanating from the center-point chosen by the administrators. In still further embodiments, predetermined area may be made up of any shape or size that may be plotted onto a map.

Still consistent with embodiments of the present disclosure, the platform may enable a user to select a zone by specifying a remote area to which the user is not otherwise located within or in proximity thereto. Such zone may be referred to as a peek zone.

To join a peek zone, the platform may enable a user to select an area on a map or an area from a list of predefined areas. As described above, the predefined areas may include, but not be limited to, for example, a region (e.g., an area defined on a map), a campus (e.g., school, mall, park), physical infrastructure (e.g., a building or set of buildings), a network connection (e.g., Wi-Fi, Local Area Network, Wide-Area network), and the like. In turn, the platform may connect the user to other users who are otherwise located within or in proximity to the selected area.

Accordingly, user-selected zones of the present disclose may be classified as peek zones), whereas zones based on dynamic parameters (e.g., user-location in proximity to dynamic or predefined areas) may be classified as dynamic zones throughout the present disclosure.

To better disclose the differences between a peek zone and a dynamic zone, the following non-limiting example is provided: a first user may a select a remote area and be connected to a second user in the area. Here, the first user may have no geographical or organizational association with the area (i.e., the first user is peeking into the area), while the second user may have a geographical or organizational association with the area (i.e., the second user is located within the area). Accordingly, the area may be classified as a peek zone for the first user, while for the second user the area may be classified as a dynamic zone. As will be detailed below, the functionality provided to user by the platform may differ based on, for example, the classification of the zone.

Having established a zone for the user (e.g., a peek or dynamic zone), the platform may connect the user to other users within the zone. Based on a corresponding classification of zone, the users' interaction with each other in the zone may be limited. For example, users within a dynamic zone may view and share content to and from others within their dynamic zone. However, users in a peek zone may be limited to only viewing the content that is being shared within their peek zone.

In yet further embodiments of the present disclosure, the zone may be tied to a subject matter, organization, affiliation, or other non-geographic parameter (hereinafter referred to as peek topics). The peek topic may be created by a user or administrator of the platform. In turn, users of the platform may select to join a zone associated with a desired category.

Consistent with embodiments of the present disclosure, platform content may be viewed and shared anonymously or with an optional, static or dynamic username. In various embodiments, the platform may be enabled to receive and display comments on content, “up votes” and “down votes” on posts, the location of where the post originated (e.g., a specific location or generalized proximate region), commands to report the post to administrators or forward the post on to others by social media channels such as Facebook, Twitter, or other similar means.

The platform may arrange and display shared content in various manners. For example, in some embodiments, the content may be displayed in order of the newest to oldest post, the most popular to least popular post, a set of posts that are related to a specified topic, or a set of posts that have originated in a specified zone. A user of the platform may be enabled to select a desired arrangement of display.

### III. PLATFORM OPERATION

FIG. 2 is a flow chart setting forth the general stages involved in a method 200 consistent with an embodiment of the disclosure for providing a platform. Method 200 may be implemented using a computing device 400 as described in more detail below with respect to FIG. 4. For the purposes of this illustrative method, computing device 400 may comprise, for example, personal computer, laptop, or a mobile computing device such as a smartphone or tablet.

Although method 200 has been described to be performed by a platform 100 (comprising computing device 400), it should be understood that, in some embodiments, different operations may be performed by different networked elements in operative communication with computing device 400. For example, a server may be employed in the performance of some or all of the stages in method 200. The server may be configured much like computing device 400. Moreover, although the content, as posted to the platform by a user, is illustrated as textual content, embodiments of the present disclosure may include any type of content (e.g., graphical and/or textual).

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 100 will be described in greater detail below.

Method 200 may begin at starting block 205 and proceed to stage 210 where platform 100 may receive a zone selection. The zone selection may be received from a user 105 having special privileges. The privileges may be that of a platform administrator or host. The privileges may enable user 105 (which may be associated with either an individual or an entity) to define a zone that user 105 would like to host.

User 105 may access a platform 100 via an admin portal. The admin portal may provide an interface for user 105. The interface may enable user 105 to perform a plurality of functions, including, but not limited to, setting a zone preference. The zone preference may indicate whether user 105 would like to host a predefined zone based on location or, for example, a predefined zone based on a category (e.g., peek topic, including, events).

In embodiments where user 105 selects a predefined zone, platform 100 may provide, via the admin portal, an interface for defining the predefined zone. The interface may enable the user to select a location or coordinates on a map or specify an address or venue. In further embodiments, the interface may enable the user to define a network location to be associated with a predefined zone.

The yet further embodiments, user 105 may select a predefined zone based on a category. The category may correspond to, for example, but not be limited to, an event, a user-type, a content type (to be shared within the zone). In various embodiments, the category may be further associated with a geographical or network location.

User 105 may define a time period for which the zone is to be hosted by user 105. Furthermore, user 105 may select which type of users may be enabled to join the zone. For example, user 105 may wish to only have those users that are within the zone based on dynamic zone parameters disclosed above. In these instances, platform 100 may disable the peek zone that would enable platform users to observe content sharing within the hosted zone if they are not within the zone based on such dynamic zone parameters (e.g., physical location of the user). Details regarding the peek zone are further described in “Zone Based Anonymous Content Sharing,” U.S. patent application Ser. No. 14/458,829, the content of which is incorporated herein in its entirety.

In other embodiments, user 105 may choose to have the peek zone feature enabled, thereby allowing platform users to join the zone, even if they are not physically located within the zone, but with a limited set of networking functionality within the zone. Details regarding the limited peek zone functionality are further described in “Zone Based Anonymous Content Sharing,” U.S. patent application Ser. No. 14/458,829, the content of which is incorporated herein in its entirety.

Still consistent with embodiments of the present disclosure, platform 100 may be enabled to receive payment from user 105 (e.g., the entity desiring to host a zone). Payment amount may vary according to the zone and the surrounding circumstances. For example, the price may vary based on geographical size or population associated with the zone. As another example, platform 100 may enable bidding between entities to determine pricing.

From stage 210, where platform 100 may receive a zone selection from an entity desiring administrative access, method 200 may advance to stage 220, where platform 100 may assign user 105 to the zone. This may enable the administrator entity to determine the displayed name of the zone.

It should be understood that user 105 may choose to host a zone that has existed prior to user 105's assignment to that zone. For example, user 105 may be a news agency covering an event located within a particular location. The news agency may request, via platform 100, to host the particular location. In this way, user 105 may become privy to the content shared by platform users within the particular location, or zone associated therewith. Furthermore, user 105 may choose to disable the peek zone feature for the hosted zone, thereby preventing any platform user not located within the zone (e.g., dynamic zone) from viewing the content shared by platform users located within the zone.

Once user 105 has been established to be a zone host, user 105 may be provided with moderation rights over the content posted to the hosted zone by platform users. Sharing content within a zone is further described in “Zone Based Anonymous Content Sharing,” U.S. patent application Ser. No. 14/458,829, the content of which is incorporated herein in its entirety. For example, the admin portal may enable user 105 to select which content may be shared and which content may not be shared to the platform users within the zone. Moderation may be employed prior to the publishing of the shared content or after the publishing of the shared content.

Still consistent with embodiments of the present disclosure, moderation rights may enable user 105 to conduct polls within their hosted zone. The polls may be based on the ‘up’ and ‘down’ voting functionality further described in “Zone Based Anonymous Content Sharing,” U.S. patent application Ser. No. 14/458,829, the content of which is incorporated herein in its entirety. Due to the anonymous nature of the content sharing in some embodiments, the poll may be held anonymously in addition to being location based.

In yet further embodiments of the present disclosure, user 105 may be enabled to post content within the zone for platform users to receive. In this way, user 105 may be enabled to provide content to users within their hosted zone. For example, user 105 may choose to publish marketing content to the hosted zone. In other embodiments, user 105 may choose to promote content shared by other users within their hosted zone. Promotion may comprise the publication of the promoted content to appear at the top of the content interface as further described in “Zone Based Anonymous Content Sharing,” U.S. patent application Ser. No. 14/458,829, the content of which is incorporated herein in its entirety.

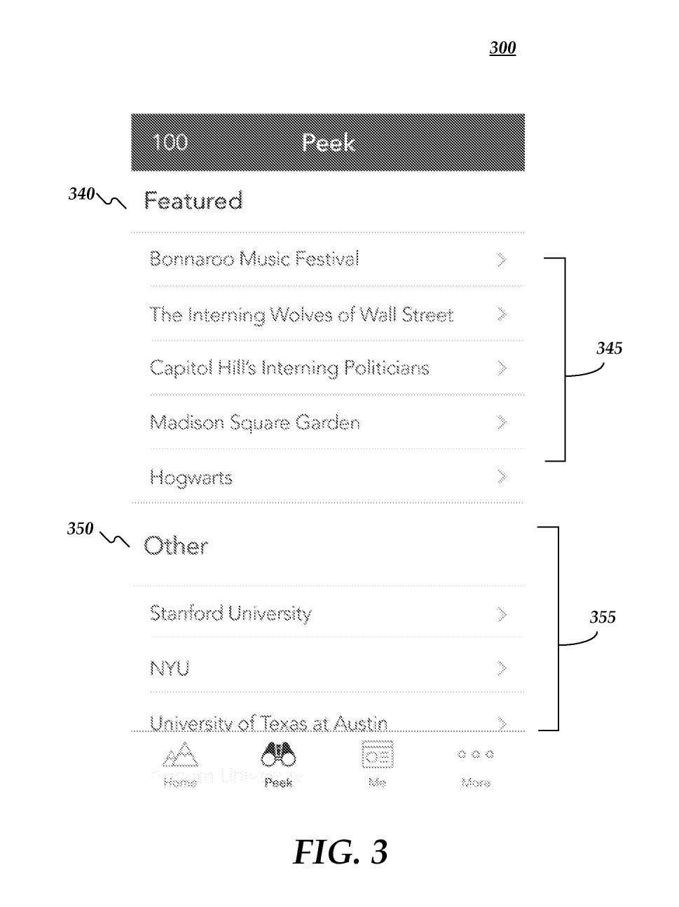

From stage 220, where computing device may assign administrative control to a specified zone, method 200 may advance to stage 230, where platform 100 may display a zone in a featured zone list. FIG. 3 illustrates one embodiment of an interface 300 for presenting zones to platform users.

Interface 300 shows a listing of hosted zones 340. Hosted zones 340 may comprise hosted zone names 345 that are selectable by platform users. The platform users may select a hosted zone to view the content within the hosted zone as further described in “Zone Based Anonymous Content Sharing,” U.S. patent application Ser. No. 14/458,829, the content of which is incorporated herein in its entirety.

In addition, interface 300 shows a listing of peek zones 350. A platform user may select any one of the peek zone names 355 to view the content within the peek zone as further described in “Zone Based Anonymous Content Sharing,” U.S. patent application Ser. No. 14/458,829, the content of which is incorporated herein in its entirety.

From stage 230, where platform 100 may display a zone as featured, method 100 may advance to stage 130, where platform 100 may enable administrative privileges to an entity. Administrative access may include features such as, for example, exclusive control of zone naming rights, ability to enable anonymous polling, moderation, payment, and priority display in featured zone list. It should be understood that user 105 may host a plurality of zones. In this case, the admin portal for user 105 may enable user 105 to administer each hosted zone.

Further administrative access features may include, but not be limited to, for example, the ability to approve or delete posts, view posts within sub-zones, sort posts based on zones, sponsor content, view user information, history and IP address, control picture rights in a zone, coupled with moderation, and view reports on users, such as, for example, breakdown of posts in a zone, frequency of posts, frequency of views, frequency of peeks, and customized reports based on filters.

### IV. PLATFORM ARCHITECTURE

Platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 400, it should be understood that, in some embodiments, different operations may be performed by different networked elements in operative communication with computing device 400.

Embodiments of the present disclosure may comprise a system having a memory storage and a processing unit. The processing unit coupled to the memory storage, wherein the processing unit is configured to perform the stages of method 200.

The processing unit and memory storage may further be configured to provide a method of providing zone allocation in a zone-based content sharing platform. The platform may be configured for receiving a selection of a zone, the zone being enabled to connect platform users associated with the zone; assigning the requested zone to a host; displaying the zone within an indication that the zone is being hosted by the host; and enabling the host to administer the zone.

In some embodiments, receiving the request to host the zone comprises receiving at least one of the following: a set of coordinates corresponding to the requested zone, a location associated with the requested zone, a name of a venue associated with the requested zone, and an event associated with the requested zone.

Still consistent with embodiments of the present disclosure, assigning the requested zone to the host may comprise enabling the host to administer the zone. Administering the zone may comprise, for example, enabling the host to moderate and/or promote the content shared within the zone. The host may further be enabled to control access to content shared within the zone. The assignment may last for a period of time. Upon the expiration of the period of time, the host may be unassigned from the zone and, thus, have their administrative control of the zone relinquished.

FIG. 4 is a block diagram of a system including computing device 400. Consistent with an embodiment of the disclosure, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the disclosure.

With reference to FIG. 4, a system consistent with an embodiment of the disclosure may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), nonvolatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include zone based 420. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., zone based application 420) may perform processes including, for example, one or more of method 200's stages as described above. The aforementioned process is an example, and processing unit 402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a request to host a zone, the zone being comprised of platform users associated with the zone;
assigning the requested zone to a host;
displaying the zone within an indication that the zone is being hosted; and
enabling the host to administer the zone.

2. The method of claim 1, wherein receiving the request to host the zone comprises receiving a set of coordinates corresponding to the requested zone.

3. The method of claim 1, wherein receiving the request to host the zone comprises receiving a location associated with the requested zone.

4. The method of claim 1, wherein receiving the request to host the zone comprises receiving a name of a venue associated with the requested zone.

5. The method of claim 1, wherein receiving the request to host the zone comprises receiving an event associated with the requested zone.

6. The method of claim 1, wherein receiving the request to host the zone comprises receiving a network location associated with the requested zone.

7. The method of claim 1, wherein assigning the requested zone to the host comprises enabling the host to set access parameters for content shared within the zone.

8. The method of claim 1, wherein assigning the requested zone to the host comprises assigning the requested zone to the host for a period of time.

9. The method of claim 8, further comprising unassigning the requested zone from the host after an expiration of the period of time.

10. The method of claim 9, further comprising disabling the host from administering the zone upon unassignment.

11. The method of claim 1, wherein enabling the host to administer the zone comprises enabling the host to moderate the content shared within the zone.

12. The method of claim 1, wherein enabling the host to administer the zone comprises enabling the host to promote content shared within the zone.

13. A computer-readable medium comprising a set of instructions which when executed perform a method comprising:
receiving a selection of a zone, the zone being enabled to connect platform users associated with the zone;
assigning the requested zone to a host;
displaying the zone within an indication that the zone is being hosted by the host; and
enabling the host to administer the zone.

14. The computer-readable medium of claim 13, wherein receiving the selection of the zone comprises receiving at least one of the following: a set of coordinates corresponding to the requested zone, a location associated with the requested zone, a name of a venue associated with the requested zone, and an event associated with the requested zone.

15. The computer-readable medium of claim 13, wherein receiving the request to host the zone comprises receiving a network location associated with the requested zone.

16. The computer-readable medium of claim 13, wherein assigning the requested zone to the host comprises enabling the host to control access to content shared within the zone.

17. The computer-readable medium of claim 13, wherein assigning the requested zone to the host comprises assigning the requested zone to the host for a period of time and unassigning the request zone form the host after an expiration of the period of time.

18. The computer-readable medium of claim 13, wherein enabling the host to administer the zone comprises enabling the host to moderate the content shared within the zone.

19. The computer-readable medium of claim 13, wherein enabling the host to administer the zone comprises enabling the host to promote content shared within the zone.

20. A system comprising:
a memory storage; and
a processing unit coupled to the memory storage, wherein the processing unit is configured to:
receive a selection of a zone, the zone being enabled to connect platform users associated with the zone, the selection comprising at least one of the following: a set of coordinates corresponding to the requested zone, a location associated with the requested zone, a name of a venue associated with the requested zone, and an event associated with the requested zone,
assign the requested zone to a host for a period of time, and
enable the host to administer the zone for the duration of the period of time.
